(19) United States
(12) Patent Application Publication
(10) Pub. No.: US 2013/0036756 A1
(43) Pub. Date: Feb. 14, 2013

(54) METHODS AND SYSTEMS FOR CONTROLLING A MOTOR

(71) Applicants: Steven Wilfred Post, Cassville, MO (US); Roger Carlos Becerra, Fort Wayne, IN (US); Kerry Baker Shelton, Fort Wayne, IN (US); Paul Nathanael Selking, Ossian, IN (US)

(72) Inventors: Steven Wilfred Post, Cassville, MO (US); Roger Carlos Becerra, Fort Wayne, IN (US); Kerry Baker Shelton, Fort Wayne, IN (US); Paul Nathanael Selking, Ossian, IN (US)

(21) Appl. No.: 13/208,034

(22) Filed: Aug. 11, 2011

(51) Int. Cl. F25D 17/06; G05D 23/19

(52) U.S. Cl. 62/186; 318/471

(57) ABSTRACT

An electric motor configured to drive an air moving device included within a heating, ventilation, and air conditioning (HVAC) system is described. The air moving device is configured to draw air through a condensing coil of the HVAC system from a first side of the condensing coil to a second side of the condensing coil. The motor includes a temperature sensor configured to measure an exhaust air temperature at the second side of the condensing coil and to generate a temperature signal that includes measured temperature information. The motor also includes a controller communicatively coupled to the temperature sensor and configured to receive the temperature signal and to control operation of the motor based at least partially on the temperature signal.

### BACKGROUND OF THE INVENTION

The embodiments described herein relate generally to controlling a motor, and more specifically, to measuring an air temperature and controlling the motor based at least partially on the measured air temperature.

Heating, ventilation, and air conditioning (HVAC) systems typically include electric motors. For example, a typical HVAC system includes a condenser unit positioned exterior to a structure being heated/cooled by the HVAC system that includes a compressor, a compressor motor, a condensing coil, and a condenser fan motor that drives a condenser fan. Typically, the condenser fan motor runs at a fixed speed.

The increasing cost of energy, for example, the electricity used to power an HVAC system, and heightened environmental concerns, have increased the demand for more efficient HVAC systems. The Air Conditioning, Heating and Refrigeration Institute defines the Seasonal Energy Efficiency Ratio (SEER) in its standard ARI 210/240, titled Performance Rating of Unitary Air-Conditioning and Air-Source Heat Pump Equipment. The SEER rating of an HVAC system is the cooling output in British thermal unit (Btu) during a typical cooling-season divided by the total electric energy input in watt-hours during the same period. The higher the SEER rating, the more energy efficient the system is. However, increasing the efficiency of an HVAC system typically increases the cost of the HVAC system.

### BRIEF DESCRIPTION OF THE INVENTION

In one aspect, an electric motor configured to drive an air moving device included within a heating, ventilation, and air conditioning (HVAC) system is provided. The air moving device is configured to draw air through a condensing coil of the HVAC system from a first side of the condensing coil to a second side of the condensing coil. The motor includes a temperature sensor configured to measure an exhaust air temperature at the second side of the condensing coil and to generate a temperature signal that includes measured temperature information. The motor also includes a controller communicatively coupled to the temperature sensor and configured to receive the temperature signal and to control operation of the motor based at least partially on the temperature signal.

In another aspect, a heating, ventilation, and air conditioning (HVAC) system is provided. The HVAC system includes a condensing coil and an air moving device configured to draw air from a first side of the condensing coil to a second side of the condensing coil. The HVAC system also includes a temperature sensor configured to measure an exhaust air temperature at the second side of the condensing coil and to generate a temperature signal that includes measured temperature information. The HVAC system also includes an electric motor including a controller and configured to drive the air moving device in response to control signals from the controller. The controller is configured to receive the temperature signal and to control operation of the electric motor based at least partially on the temperature signal.

In yet another aspect, a method for controlling a fan motor configured to draw air through a condensing coil of a heating, ventilation, and air conditioning (HVAC) system from a first side of the condensing coil to a second side of the condensing coil is provided. The method includes measuring an exhaust air temperature at the second side of the condensing coil and controlling a speed of rotation of the fan motor based at least partially on the measured temperature.

### BRIEF DESCRIPTION OF THE DRAWINGS

FIG. 1 is a schematic diagram of an exemplary heating, ventilation, and air conditioning (HVAC) system.

FIG. 2 is a cut-away perspective view of an exemplary outside condenser unit that may be included in the HVAC system shown in FIG. 1.

FIG. 3 is a curve illustrating an exemplary relationship between a rotational speed of the fan motor shown in FIG. 1 and a condensing coil exhaust air temperature.

FIG. 4 is a control diagram of exemplary control signals used to control the fan motor shown in FIG. 1.

FIG. 5 is a flow chart of an exemplary method for controlling the fan motor shown in FIG. 1.

### DETAILED DESCRIPTION OF THE INVENTION

The methods and systems described herein facilitate increasing an energy efficiency of an HVAC system. The overall energy usage of the HVAC system is reduced by reducing an operating speed of the condenser fan motor when operating the condenser fan motor at a higher speed would not benefit cooling/heating.

Technical effects of the methods, systems, and computer-readable media described herein include at least one of: (a) measuring an exhaust air temperature at the second side of the condensing coil; and (b) controlling a speed of rotation of the fan motor based at least partially on the measured temperature.

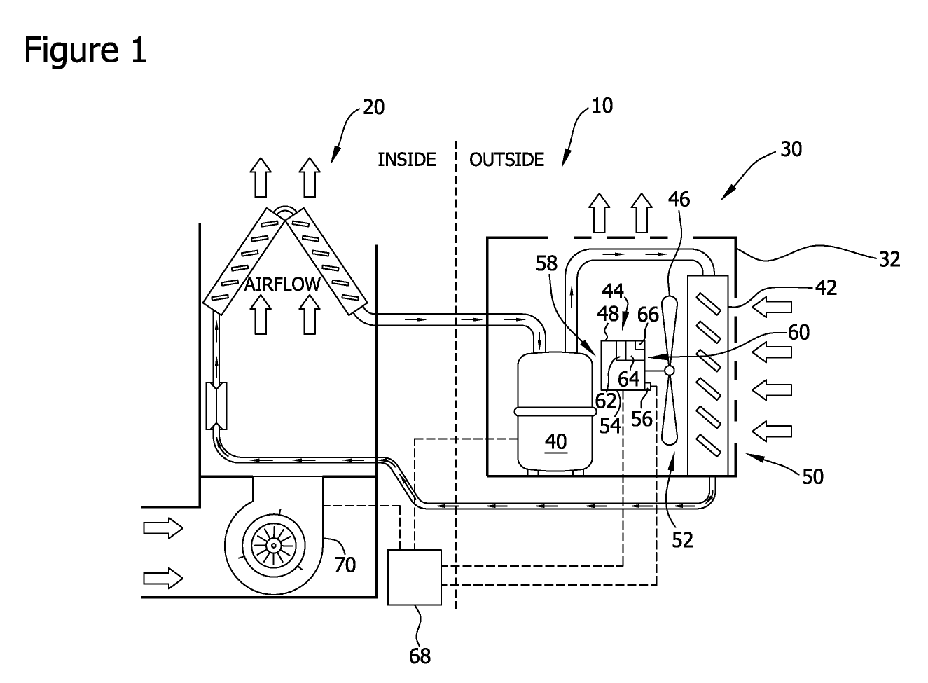

FIG. 1 is a schematic diagram of an exemplary heating, ventilation, and air conditioning (HVAC) system 10. In the exemplary embodiment, HVAC system 10 includes an interior portion 20 and an exterior portion 30. Interior portion 20 is positioned at least partially within an interior of a structure being cooled/heated by HVAC system 10. Exterior portion 30 is positioned exterior to the structure being cooled/heated. Exterior portion 30 includes an outside condenser unit 32.

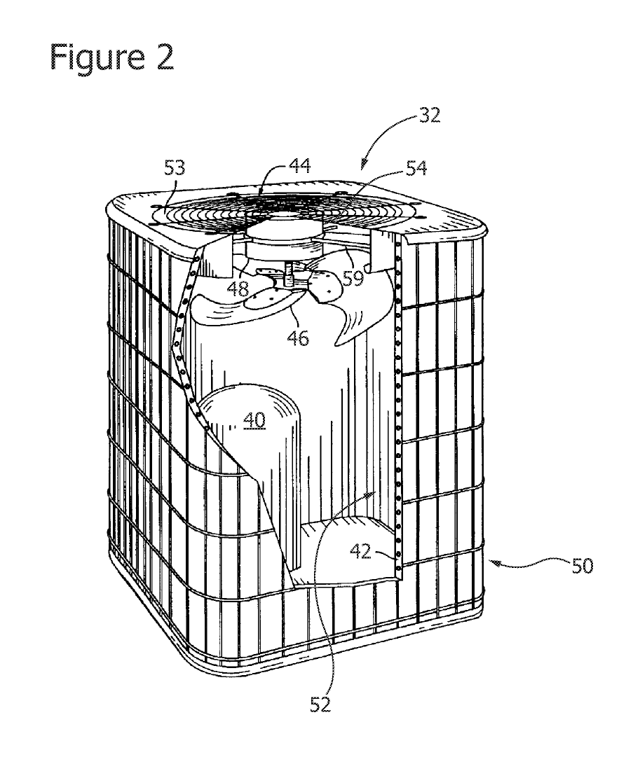

FIG. 2 is a cut-away perspective view of an exemplary outside condenser unit 32 that may be included in HVAC system 10 (shown in FIG. 1). Referring now to FIGS. 1 and 2, condenser unit 32 includes a compressor 40, a condensing coil 42, and an air moving apparatus 44. In the exemplary embodiment, air moving apparatus 44 includes an air moving device, for example, a fan 46, and an electric motor 48 coupled to, and configured to drive, fan 46 which draws air from a first side 50 of condensing coil 42 to a second side 52 of condensing coil 42. More specifically, air moving apparatus 44 draws air from first side 50 to second side 52 of condensing coil 42 (e.g., from an exterior to an interior of outside condenser unit 30), and expels the air through an exhaust opening 53 defined within a surface of condenser unit 32.

In the exemplary embodiment, motor 48 includes a housing 54 and a temperature sensor 56, for example, a temperature transducer, coupled to an exterior 58 of housing 54. Although described as coupled to housing 54, temperature sensor 56 may be coupled to a motor mounting 59, coupled to wiring (not shown in FIG. 1 or 2) that leads to motor 48, and/or positioned anywhere within condenser unit 32 that allows temperature sensor 56 to measure a temperature of the exhaust air stream from condensing coil 42. In the exemplary embodiment, insulation and/or a heat shield is positioned between temperature sensor 56 and housing 54 to prevent heat generated by motor 48 from interfering with the measurement of the exhaust air temperature. Moreover, in the exemplary embodiment, temperature sensor 56 is positioned such that it is protected from direct sunlight, since direct sunlight may also prevent temperature sensor 56 from accurately measuring the exhaust air temperature.

In the exemplary embodiment, fan motor 48 includes a motor controller 60 for controlling operation of fan motor 48. Controller 60 may include a processor 62 and a memory device 64. Controller 60 may also include a communication interface 66 that allows a user to communicate with controller 60, for example, to select and/or edit data stored within memory device 64. Communication interface 66 may include, but is not limited to, a serial communication adapter, a parallel communication adapter, and/or a plurality of selectable taps.

In the exemplary embodiment, controller 60 is communicatively coupled to temperature sensor 56 and is configured to receive a temperature signal corresponding to a measured temperature from temperature sensor 56. In the exemplary embodiment, motor 48 is a variable speed motor and controller 60 provides motor 48 with a control signal corresponding to a desired speed of operation for motor 48. Controller 60 determines the desired speed of operation based at least partially on the measured temperature from temperature sensor 56. The exhaust air temperature is an indicator of the loading on compressor 40. The load on compressor 40 varies based on, for example, but not limited to, an ambient air temperature exterior to condenser unit 32 and contaminants present in and/or on condensing coil 42 that restrict airflow through condensing coil 42. Varying the speed of rotation of motor 48 increases an overall efficiency of HVAC system 10 by allowing motor 48 to run at a lower speed, and therefore consume less energy, when the measured temperature allows. The reduction in energy consumption by motor 48 increases a SEER rating of HVAC system 10.

In some embodiments, HVAC system 10 includes a system controller 68. System controller 68 is configured to control operation of, for example, an indoor blower 70, compressor 40, and other components within HVAC system 10. In an alternative embodiment, system controller 68 is communicatively coupled to temperature sensor 56 and is configured to receive a temperature signal corresponding to a measured temperature from temperature sensor 56. In the alternative embodiment, system controller 68 determines a desired speed of operation for fan motor 48 based at least partially on the measured temperature from temperature sensor 56 and provides fan motor 48 with a control signal corresponding to the desired speed of rotation.

More specifically, when HVAC system 10 is in a cooling mode (e.g., an air conditioning mode) and the outlet air temperature measured by sensor 56 is high, controller 60 operates motor 48 at a first speed, providing a first level of airflow over condensing coil 42. When the outlet air temperature measured by sensor 56 is lower, controller 60 operates motor 48 at a second speed, wherein the second speed is slower than the first speed. Operating motor 48 at the second speed provides a second level of airflow over condensing coil 42, i.e., a lower level of airflow over condensing coil 42. Operating motor 48 at the second speed when the outlet air temperature allows does not adversely affect the cooling provided by HVAC system 10, while creating an overall energy savings.

Conversely, when HVAC system 10 is in a heating mode (e.g., a heat pump mode) and the outlet air temperature measured by sensor 56 is low, controller 60 operates motor 48 at a first speed, providing a first level of airflow over condensing coil 42. When the outlet air temperature measured by sensor 56 is higher, controller 60 operates motor 48 at a second speed, wherein the second speed is slower than the first speed. Operating motor 48 at the second speed provides a second, lower level of airflow over condensing coil 42. Operating motor 48 at the second speed reduces an energy usage of motor 48.

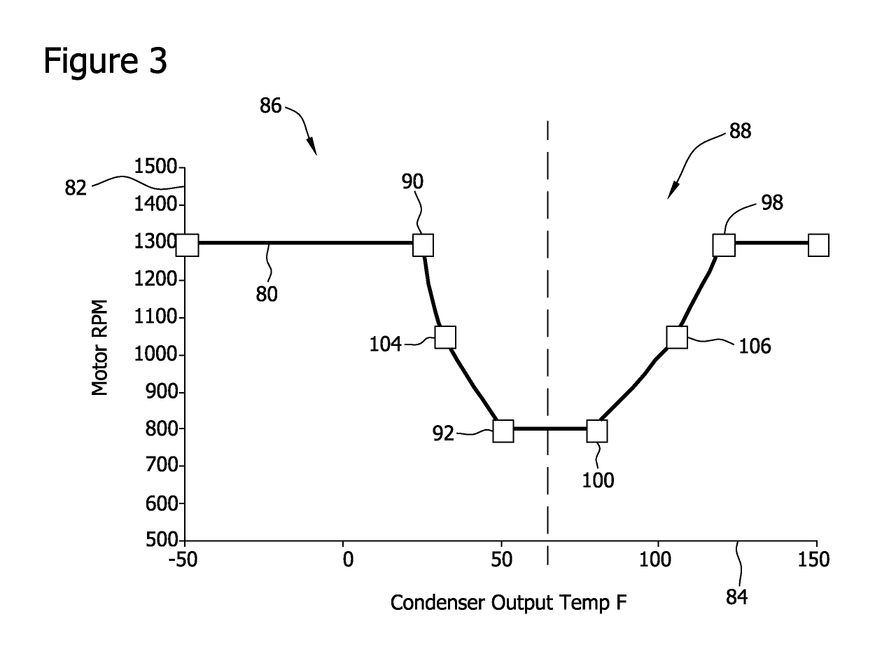

FIG. 3 is a curve 80 illustrating an exemplary relationship between a rotational speed 82 of a motor, for example, motor 48, and a condensing coil exhaust air temperature 84. The temperature vs. motor speed relationship illustrated in FIG. 3 is provided as one example of how a speed of a fan motor may be controlled based on a measured temperature. The values for motor speed and for measured temperature provided in FIG. 3 are examples only and actual values for measured temperature and corresponding motor speed may be customized for the specific HVAC application into which fan motor 48 is to be installed.

In the example shown in FIG. 3, a first portion 86 of curve 80 illustrates the rotational speeds 82 at which fan motor 48 will be operated while HVAC system 10 is in a heating mode of operation. A second portion 88 of curve 80 illustrates the rotational speeds 82 at which fan motor 48 will be operated while HVAC system 10 is in a cooling mode of operation. For example, fan motor 48 is operated at a constant rotational speed 82 when exhaust temperature 84 is below a first temperature 90, for example, approximately 25 degrees Fahrenheit. At exhaust air temperatures above first temperature 90, and below a second temperature 92, the rotational speed at which fan motor 48 is operated is reduced. The exhaust air temperature is an indicator of the loading on compressor 40. More specifically, the closer the exhaust air temperature is to the indoor temperature HVAC system 10 is set to provide, the lower the load is on compressor 40. Therefore, as the exhaust air temperature approaches the indoor temperature HVAC system 10 is set to provide, the airflow provided by air moving apparatus 44 (shown in FIG. 1) can be reduced without adversely affecting performance of HVAC system 10.

In cooling mode, fan motor 48 is operated at a constant rotational speed 82 when exhaust air temperature 84 is above a third temperature 98, for example, 110 degrees Fahrenheit. At exhaust air temperatures below third temperature 98, and above a fourth temperature 100, the rotational speed at which fan motor 48 is operated is reduced. More specifically, the closer the exhaust air temperature is to the indoor temperature HVAC system 10 is set to provide, the lower the load is on compressor 40. Operating fan motor 48 at a lower rotational speed when the load on compressor 40 allows for reduced airflow across condensing coil 42 reduces energy consumption by fan motor 48 and therefore increases the energy efficiency of HVAC system 10.

In the example shown in FIG. 3, curve 80 includes a fifth point 104 and a sixth point 106. Fifth point 104 and sixth point 106 are included within curve 80 so that the speed of the fan motor may be controlled in a non-linear fashion with respect to measured temperature. Defining a non-linear temperature/motor speed relationship provides additional motor speed control flexibility.

In the exemplary embodiment, operating instructions are stored within memory device 64 (shown in FIG. 1). In the exemplary embodiment, the operating instructions include an algorithm configured to control the speed of fan motor 48 in accordance with the temperature/speed relationship illustrated in FIG. 3. Moreover, a user may provide controller 60 with a customization signal via communication interface 66 (shown in FIG. 1). In response to the customization signal, controller 60 may change variables included within the stored algorithm, or select a specific algorithm from a plurality of stored algorithms, to match the algorithm to specific HVAC system requirements.

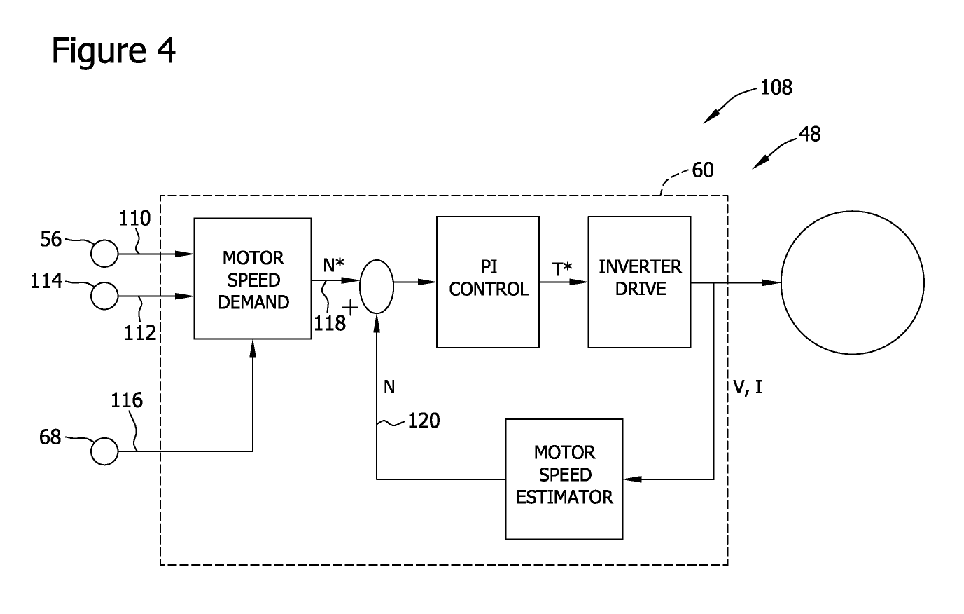

FIG. 4 is a control diagram 108 of exemplary control signals used to control a fan motor, for example, fan motor 48 (shown in FIG. 1). In the exemplary embodiment, controller 60 receives a first temperature signal 110 from a temperature sensor, for example, temperature sensor 56. In an alternative embodiment, controller 60 also receives a second temperature signal 112 from a second temperature sensor 114. In the alternative embodiment, first temperature signal 110 corresponds to a temperature of the exhaust air stream from condensing coil 42 (shown in FIG. 1) and second temperature signal 112 corresponds to an ambient air temperature. For example, second temperature sensor 114 may be positioned at first side 50 of condensing coil 42 (both shown in FIG. 1) in order to measure the ambient air temperature surrounding condenser unit 32 (shown in FIG. 1). The ambient air temperature and/or a comparison of the exhaust air temperature to the ambient air temperature may provide additional information regarding the load on compressor 40.

In the exemplary embodiment, controller 60 receives a mode selection signal 116 from, for example only, system controller 68. Controller 60 generates a motor speed demand 118 based at least partially on first temperature signal 110, second temperature signal 114, and mode selection signal 116. For example, based on mode selection signal 116, controller 60 may select a specific motor speed vs. temperature curve, for example, curve 80 (shown in FIG. 3), from the curves stored in memory device 64 (shown in FIG. 1). Controller 60 generates motor speed demand 118, which corresponds to the motor speed associated with the measured temperature (e.g., the motor speed found on chart 80 associated with the measured temperature). Motor speed demand 118 and a current measured motor operating speed signal 120 are both provided to a proportional integral controller and inverter drive, which are typically also included within controller 60. By comparing the measured motor operating speed signal 120 to the motor speed demand signal 118, closed loop control of the speed of motor 48 is achieved.

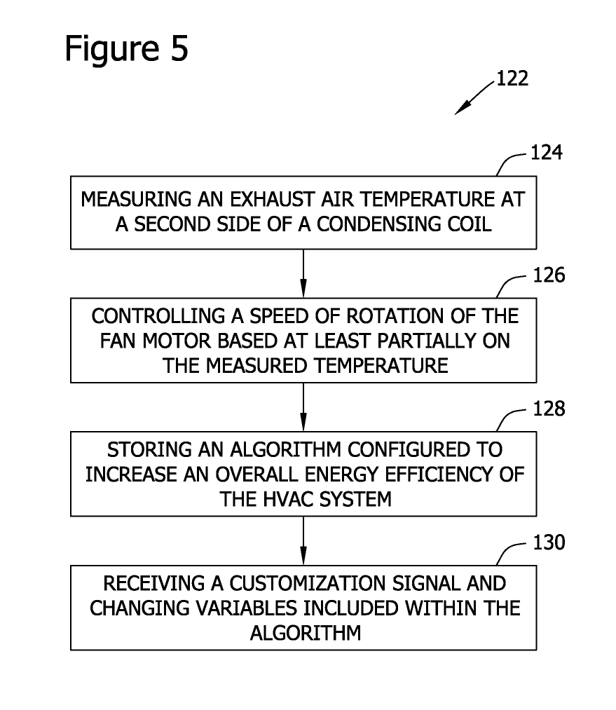

FIG. 5 is a flow chart of an exemplary method 122 for controlling a fan motor, for example, fan motor 48 (shown in FIG. 1) included within an HVAC system, for example, HVAC system 10 (shown in FIG. 1). In the exemplary embodiment, method 122 includes measuring 124 an exhaust air temperature at a second side of a condensing coil, for example, second side 52 of condensing coil 42 (shown in FIG. 1). In the exemplary embodiment, method 122 also includes controlling 126 a speed of rotation of fan motor 48 based at least partially on the measured temperature. Controlling 126 the speed of rotation includes at least one of decreasing the motor speed as the exhaust air temperature decreases when in an HVAC system cooling mode and decreasing the motor speed as the exhaust air temperature increases when in an HVAC system heating mode.

Method 122 may also include storing 128 an algorithm configured to increase an overall energy efficiency of HVAC system 10, compared to fixed-speed operation of fan motor 48, by determining a speed at which to rotate fan motor 48 based at least partially on the measured temperature. In the exemplary embodiment, the algorithm is stored in a motor controller, for example, controller 60 (shown in FIG. 1). Method 122 may also include receiving 130 a customization signal and changing variables included within the stored algorithm based on the customization signal to match the algorithm to specific HVAC system requirements.

Described herein are exemplary methods and systems for controlling a fan motor included within an HVAC system. More specifically, an electric motor is described herein that is equipped with electronics to vary the speed of a condenser/heat pump evaporator fan responsive to the condenser/heat pump evaporator outlet air temperatures so as to increase the efficiency of the HVAC system when compared to fixed-speed operation of the condenser/heat pump evaporator motor. The methods and systems described herein facilitate reducing the overall energy usage of the HVAC system by reducing an operating speed of the condenser fan motor when operating the condenser fan motor at a higher speed would not benefit cooling/heating. The methods and systems described herein determine when the loading on the compressor is at a low enough level that a reduced airflow across the condensing coils will provide adequate heat transfer by the condensing coils.

The methods and systems described herein facilitate efficient and economical operation of an HVAC system. Exemplary embodiments of methods and systems are described and/or illustrated herein in detail. The methods and systems are not limited to the specific embodiments described herein, but rather, components of each system, as well as steps of each method, may be utilized independently and separately from other components and steps described herein. Each component, and each method step, can also be used in combination with other components and/or method steps.

When introducing elements/components/etc. of the methods and apparatus described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electric motor configured to drive an air moving device included within a heating, ventilation, and air conditioning (HVAC) system, wherein the air moving device is configured to draw air through a condensing coil of the HVAC system from a first side of the condensing coil to a second side of the condensing coil, said motor comprising:
a temperature sensor configured to measure an exhaust air temperature at the second side of the condensing coil and to generate a temperature signal that includes measured temperature information; and
a controller communicatively coupled to said temperature sensor and configured to receive the temperature signal and to control operation of said motor based at least partially on the temperature signal.

2. An electric motor in accordance with claim 1, wherein said controller stores an algorithm configured to increase an overall energy efficiency of the HVAC system by adjusting a speed of said electric motor in response to the measured temperature.

3. An electric motor in accordance with claim 2, wherein said controller stores a plurality of algorithms, each algorithm configured to increase an overall energy efficiency of the HVAC system in a different HVAC system operating mode.

4. An electric motor in accordance with claim 2, wherein said algorithm comprises temperature and speed relationships for an HVAC system cooling mode and an HVAC system heating mode.

5. An electric motor in accordance with claim 4, wherein said controller is configured to decrease the motor speed as the exhaust air temperature decreases when in the HVAC system cooling mode.

6. An electric motor in accordance with claim 4, wherein said controller is configured to decrease the motor speed as the exhaust air temperature increases when in the HVAC system heating mode.

7. An electric motor in accordance with claim 1, wherein said electric motor comprises a housing and said controller is positioned at least partially within said housing.

8. An electric motor in accordance with claim 7, wherein said temperature sensor is coupled to an exterior of said housing.

9. An electric motor in accordance with claim 1, wherein said controller further comprises a communication interface configured to receive a customization signal and to change variables included within said algorithm based on the customization signal to match said algorithm to specific HVAC system requirements.

10. A heating, ventilation, and air conditioning (HVAC) system comprising:
a condensing coil comprising a first side and a second side;
an air moving device configured to draw air from said first side of said condensing coil to said second side of said condensing coil;
a temperature sensor configured to measure an exhaust air temperature at said second side of said condensing coil and to generate a temperature signal that includes measured temperature information; and
an electric motor comprising a controller and configured to drive said air moving device in response to control signals from said controller, said controller configured to receive the temperature signal and to control operation of said electric motor based at least partially on the temperature signal.

11. An HVAC system in accordance with claim 10, wherein said controller stores an algorithm configured to increase an overall energy efficiency of the HVAC system by adjusting a speed of said electric motor in response to the measured temperature.

12. An HVAC system in accordance with claim 11, wherein the algorithm comprises temperature and speed relationships for an HVAC system cooling mode and an HVAC system heating mode.

13. An HVAC system in accordance with claim 12, wherein said controller is configured to decrease the motor speed as the exhaust air temperature decreases when in the HVAC system cooling mode.

14. An HVAC system in accordance with claim 12, wherein said controller is configured to decrease the motor speed as the exhaust air temperature increases when in the HVAC system heating mode.

15. An HVAC system in accordance with claim 10, wherein said electric motor comprises a housing and said controller is positioned at least partially within said housing.

16. An HVAC system in accordance with claim 15, wherein said temperature sensor is coupled to an exterior of said housing.

17. A method for controlling a fan motor configured to draw air through a condensing coil of a heating, ventilation, and air conditioning (HVAC) system from a first side of the condensing coil to a second side of the condensing coil, said method comprising:
measuring an exhaust air temperature at the second side of the condensing coil; and
controlling a speed of rotation of the fan motor based at least partially on the measured temperature.

18. A method in accordance with claim 17, wherein controlling a speed of rotation of the fan motor comprises at least one of decreasing the motor speed as the exhaust air temperature decreases when in an HVAC system cooling mode and decreasing the motor speed as the exhaust air temperature increases when in an HVAC system heating mode.

19. A method in accordance with claim 17, further comprising storing an algorithm configured to increase an overall energy efficiency of the HVAC system by determining a speed at which to rotate the fan motor based at least partially on the measured temperature.

20. A method in accordance with claim 19, further comprising receiving a customization signal and changing variables included within the algorithm based on the customization signal to match the algorithm to specific HVAC system requirements.
